(19) United States
(12) Patent Application Publication
(10) Pub. No.: US 2026/0009267 A1
(43) Pub. Date: Jan. 8, 2026

(54) Flush Handle Assembly

(71) Applicant: Illinois Tool Works Inc., Glenview, IL (US)

(72) Inventors: Penghui Yi, Shanghai (CN); Bin Chen, Shanghai (CN)

(21) Appl. No.: 19/259,923

(22) Filed: Jul. 3, 2025

(30) Foreign Application Priority Data
Jul. 4, 2024 (CN) 202410897842.5
Aug. 15, 2024 (CN) 202411125848.7
Jun. 30, 2025 (CN) 202510900240.5

(51) Int. Cl. E05B 77/06; B60J 5/04; E05B 85/10

(52) U.S. Cl. CPC E05B 77/06; E05B 85/107; B60J 5/04

(57) ABSTRACT

A handle assembly having a handle seat, a handle, a pushing member, a limiting member, an inertia member. The handle is connected to the handle seat and has a retracted position and a deployed position. The pushing member is movably provided on the handle seat and has a locked state and a released state. The pushing member is capable of driving the handle to move when moving. The limiting member is movably provided on the handle seat and has a blocking position in which the limiting member holds the pushing member in the locked state and a non-blocking position in which the limiting member releases the pushing member to switch the pushing member from the locked state to the released state. The inertia member is configured to hold the limiting member in the blocking position when in its initial position, and is configured to move away from the initial position relative to the handle seat in response to an acceleration of the vehicle exceeding a threshold, such that the limiting member moves from the blocking position to the non-blocking position to release the pushing member, thereby allowing the pushing member to move to drive the handle to move from the retracted position to the deployed position.

### RELATED APPLICATIONS

The present application claims the benefit of Chinese Patent Application Nos. 202410897842.5, filed Jul. 4, 2024, 202411125848.7, filed Aug. 15, 2024, and 202510900240.5, filed Jun. 30, 2025, each titled “Flush Handle Assembly,” the contents of which are hereby incorporated by reference.

### TECHNICAL FIELD

The present disclosure generally relates to a handle assembly and a vehicle having same.

### BACKGROUND

A handle for a vehicle has a retracted position and a deployed position. When the handle is in the retracted position, an outer surface of the handle is flush with a vehicle exterior sheet metal, such that an operator cannot unlock and open the vehicle door by grasping the handle. When the door needs to be opened, the handle is driven by a motor to move to the deployed position. When the handle is in the deployed position, the handle protrudes out relative to the vehicle exterior sheet metal, such that the operator can grasp the handle to unlock and open the door.

### SUMMARY

The present disclosure relates generally to a handle assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a simplified illustrative view of a handle assembly of the present disclosure when a handle is in a retracted position.

FIG. 1B is a simplified illustrative view of the handle assembly shown in FIG. 1A when the handle is in a deployed position.

FIG. 2A is a simplified illustrative view of an embodiment of the handle assembly shown in FIG. 1A when the handle is in the retracted position.

FIG. 2B is a simplified illustrative view of the handle assembly shown in FIG. 2A when the handle is in the deployed position.

FIG. 3A is a front perspective view of another embodiment of the handle assembly shown in FIG. 1A.

FIG. 3B is a rear perspective view of the handle assembly shown in FIG. 3A.

FIG. 4A is a perspective view of an inertia drive device shown in FIG. 3B.

FIG. 4B is an exploded view of the inertia drive device shown in FIG. 4A.

FIG. 4C is a cross-sectional view of some components of the inertia drive device shown in FIG. 4A taken along line A-A in FIG. 3A.

FIG. 4D is a cross-sectional perspective view of some components of the inertia drive device shown in FIG. 4A.

FIG. 5A shows the inertia drive device shown in FIG. 3B in a working state in which a pushing member is locked by a limiting member and the handle is in the retracted position.

FIG. 5B shows the inertia drive device shown in FIG. 3B in another working state in which the pushing member has just been released by the limiting member and the handle is still in the retracted position.

FIG. 5C shows the inertia drive device shown in FIG. 3B in another working state in which the pushing member pushes the handle to the deployed position.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

It has been found that a motor may fail to work in the event of a vehicle collision and thus fail to drive the handle from the retracted position to the deployed position, resulting in the door being unable to be opened properly.

In order to at least partially solve the above technical problems, in a first aspect of the present disclosure, the present disclosure provides a handle assembly. The handle assembly comprises a handle seat, a handle, a pushing member, a limiting member, an inertia member. The handle is connected to the handle seat and has a retracted position and a deployed position. The pushing member is movably provided on the handle seat and having a locked state and a released state. The pushing member is capable of driving the handle to move when moving. The limiting member is movably provided on the handle seat and has a blocking position in which the limiting member holds the pushing member in the locked state and a non-blocking position in which the limiting member releases the pushing member to switch the pushing member from the locked state to the released state. The inertia member is configured to hold the limiting member in the blocking position when in its initial position. The inertia member is configured to move away from the initial position relative to the handle seat in response to an acceleration of the vehicle exceeding a threshold, such that the limiting member moves from the blocking position to the non-blocking position to release the pushing member, thereby allowing the pushing member to move to drive the handle to move from the retracted position to the deployed position.

In some embodiments, the handle assembly further comprises a first biasing member arranged between the pushing member and the handle seat and configured to apply a first biasing force to the pushing member to push the pushing member to move when the pushing member is in the released state.

In some embodiments, the handle seat comprises a blocking wall and the inertia member is located between the blocking wall and the limiting member when in the initial position. The handle assembly further comprises a second biasing member which is arranged between the limiting member and the handle seat and configured to apply a second biasing force to the limiting member to hold the inertia member in the initial position by means of the limiting member and the blocking wall.

In some embodiments, the limiting member comprises a support end. The inertia member abuts against the support end when in the initial position, and separates from the support end when the inertia member moves relative to the handle seat in response to the acceleration of the vehicle exceeding a threshold to allow the limiting member to move toward the blocking wall to the non-blocking position under the action of the second biasing force

In some embodiments, the limiting member comprises a blocking portion and a channel with the channel being farther from the blocking wall than the blocking portion. The blocking portion engages with the pushing member when the limiting member is in the blocking position, and the channel aligns with the pushing member when the limiting member is in the non-blocking position to allow at least part of the pushing member to pass through the channel to drive the handle.

In some embodiments, the limiting member comprises a support seat defining a clamping space between the support seat and the blocking wall, and the inertia member is accommodated in the clamping space. When the inertia member moves relative to the handle seat in response to the acceleration of the vehicle exceeding a threshold, the inertia member is movable on the support seat relative to the support seat. Along the movement path of the inertia member relative to the support seat, a distance between a surface of the support seat and the blocking wall gradually decreases, such that the movement of the inertia member relative to the support seat drives the limiting member to move away from the blocking wall to the non-blocking position.

In some embodiments, at least one of the surface of the support seat and the blocking wall has a concave shape.

In some embodiments, the handle seat comprises a first accommodating housing which forms the blocking wall. The first accommodating housing defines a first chamber and has an opening in communication with the first chamber. The limiting member further comprises a limiting rod with the support seat being provided on one end of the limiting rod. The inertia member and the support seat are located in the first chamber, and the limiting rod of the limiting member is movable in the opening.

In some embodiments, the limiting member comprises a blocking portion provided on the limiting rod, and the pushing member comprises a blocked portion. The blocked portion is engaged with the blocking portion when the limiting member is in the blocking position, and the blocked portion is disengaged from the blocking portion when the limiting member is in the non-blocking position.

In some embodiments, the blocking portion comprises a first angled surface and the blocked portion comprises a second angled surface. The first angled surface and the second angled surface mate with each other to guide the pushing member to return from the released state to the locked state.

In some embodiments, the second biasing member is disposed in the first chamber between the support seat and the first accommodating housing.

In some embodiments, the handle seat comprises a second accommodating housing which defines a second chamber and has a hole in communication with the chamber. The blocked portion of the pushing member is located in the second chamber, and the pushing member is capable of at least partially extending out of the second chamber through the hole to drive the handle. The second accommodating housing is provided with a window, and the blocking portion of the limiting member at least partially passes through the window and inserts into the second chamber to engage with the blocked portion.

In some embodiments, the first biasing member is disposed in the second chamber between the pushing member and the second accommodating housing.

In some embodiments, the inertia member is an inertia ball.

In a second aspect of the present disclosure, the present disclosure provides a vehicle comprises a handle assembly according to the present disclosure.

The present disclosure provides an inertia member which can move relative to the handle seat in response to the acceleration of the vehicle exceeding a threshold, causing the pushing member to push the handle. Thus, in the case of using the handle assembly according to the present disclosure, when the acceleration of the vehicle exceeds a threshold in the event of a collision, falling, etc., the handle can be driven to the deployed position without relying on the motor.

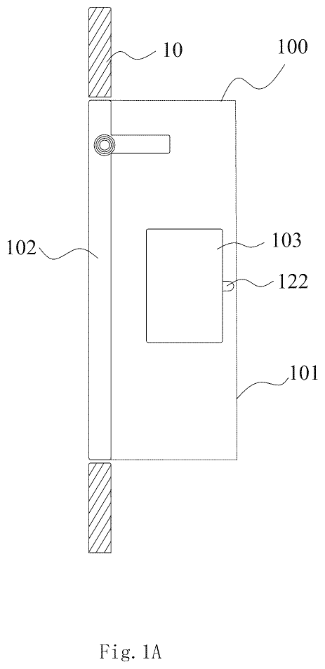

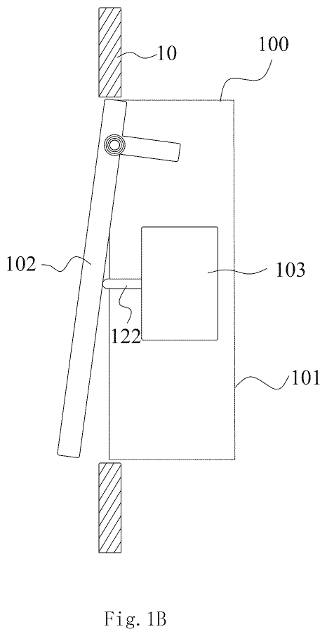

FIGS. 1A and 1B are simplified illustrative views of a handle assembly 100 of the present disclosure. FIG. 1A shows that a handle 102 is in a retracted position, and FIG. 1B shows that the handle 102 is in a deployed position. As shown in FIG. 1A, the handle assembly 100 includes a handle seat 101 and a handle 102. The handle 102 is connected to the handle seat 101, and has the retracted position and the deployed position. When there is no need to use the handle 102, the handle 102 is held in the retracted position, and an outer surface of the handle 102 is flush with a vehicle exterior sheet metal 10. When it is desired to use the handle 102, the handle 102 is driven to the deployed position to protrude out relative to the vehicle exterior sheet metal 10, to expose the part for an operator to operate, such that the operator can grasp the handle 102 to open the door (not shown). Under normal operation of the vehicle, the handle 102 is driven by a motor (not shown) to move from the retracted position to the deployed position.

As shown in FIGS. 1A and 1B, the handle assembly 100 further includes an inertia drive device 103. The inertia drive device 103 pushes, independently of the motor, the handle 102 from the retracted position to the deployed position. The inertia drive device 103 includes a pushing member 122. The pushing member 122 is movably provided on the handle seat 101, and has a locked state as shown in FIG. 1A and a released state as shown in FIG. 1B. As shown in FIG. 1B, the pushing member 122 can drive the handle 102 to move from the retracted position to the deployed position when the pushing member 122 is moving. The configuration of the handle assembly 100 according to various embodiments is described in detail below.

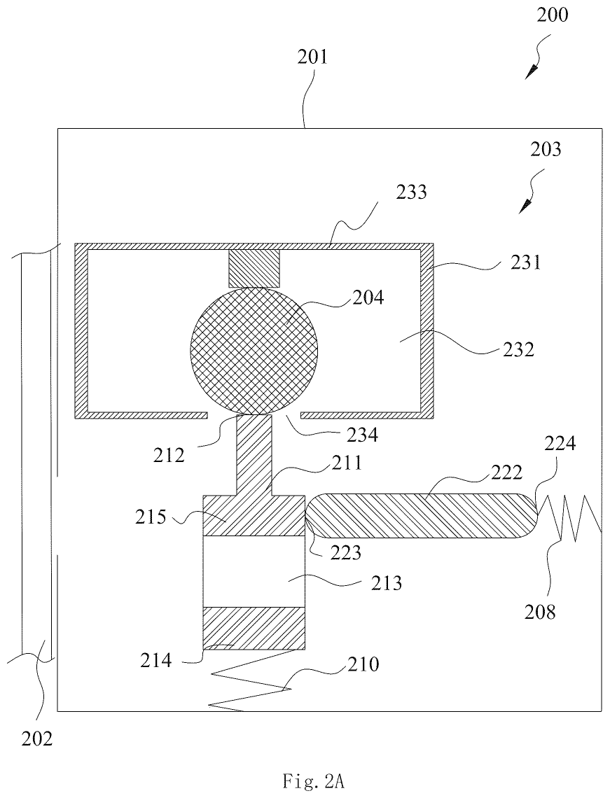

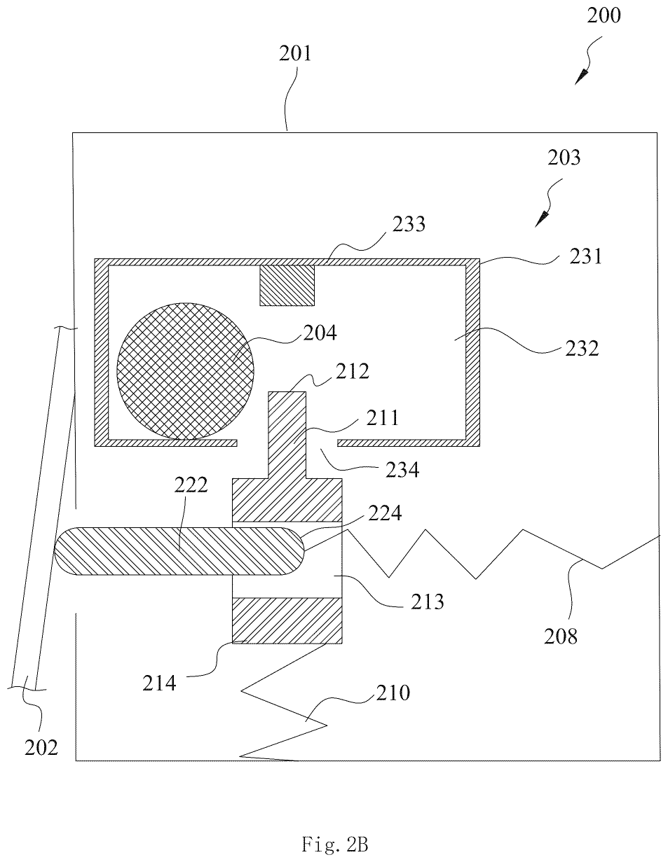

FIGS. 2A and 2B are simplified illustrative cross-sectional views of a handle assembly 200 according to an embodiment of the present disclosure, illustratively showing the overall structure of the handle assembly 200. FIG. 2A shows that a handle 202 is in a retracted position, and FIG. 2B shows that the handle 202 is in a deployed position. As shown in FIGS. 2A and 2B, the handle assembly 200 includes a handle seat 201, an handle 202, and an inertia drive device 203. The handle 202 is connected to the handle seat 201, and the inertia drive device 203 is provided on the handle seat 201. The inertia drive device 203 includes an inertia member 204, a first biasing member 208, a second biasing member 210, a limiting member 211, and a pushing member 222. As shown in the figures, the first biasing member 208 and the second biasing member 210 are springs. In other embodiments, the first biasing member and the second biasing member in other forms may be used.

The inertia member 204 has an initial position as shown in FIG. 2A. As shown in FIGS. 2A and 2B, the handle seat 201 includes an accommodating housing 231 defining a chamber 232. The inertia member 204 is accommodated in the chamber 232 and can move in the chamber 232. The accommodating housing 231 is formed with a blocking wall 233 and an opening 234 opposite to the blocking wall 233. The opening 234 is in communication with the chamber 232, allowing the limiting member 211 to move therein toward the blocking wall 233. As shown in FIG. 2A, when the inertia member 204 is in the initial position, the inertia member 204 is located between the blocking wall 233 and the limiting member 211.

In the event of an external collision, a vehicle generates a large instantaneous acceleration which is usually greater than 30 g (“g” representing a gravitational acceleration). The inertia member 204 can move away from the initial position relative to the handle seat 201 in response to the acceleration of the vehicle exceeding a threshold (e.g., exceeding the above acceleration value). As shown in FIG. 2B, when the inertia member 204 moves away from the initial position, the inertia member 204 moves away from the limiting member 211 and is thus not located between the blocking wall 233 and the limiting member 211. In the embodiment shown in FIGS. 2A and 2B, the inertia member 204 is not blocked in any direction except for the positions where the inertia member 204 abuts against the blocking wall 233 and the limiting member 211. Therefore, when an acceleration of the vehicle resulting from an external collision from any direction exceeds a threshold in any horizontal direction, the inertia member 204 can move away from the limiting member 211. In other words, the inertia member 204 can move away from the initial position relative to the handle seat 201 in response to an acceleration of the vehicle resulting from an external collision from any direction exceeding a threshold in any horizontal direction. In the embodiment as shown in the figures, the inertia member 204 is an inertia ball. In other embodiments, the inertia member 204 may be in other forms, as long as it can be held between the blocking wall 233 and the limiting member 211 when in the initial position and can move away from the initial position relative to the handle seat 201 in response to an acceleration of the vehicle exceeding a threshold. Although the inertia member 204 is shown accommodated in the chamber 232 of the accommodating housing 231, in other embodiments, only the blocking wall 233 may be provided but without the accommodating housing 231, as long as the inertia member 204 can be held in the initial position by the blocking wall 233 and the limiting member 211.

The limiting member 211 and the pushing member 222 are both movably provided on the handle seat 201. The pushing member 222 has a locked state as shown in FIG. 2A and a released state as shown in FIG. 2B, and can drive the handle 202 when moving as shown in FIG. 2B. The limiting member 211 has a blocking position as shown in FIG. 2A and a non-blocking position as shown in FIG. 2B. When the inertia member 204 is in the initial position, the inertia member 204 holds the limiting member 211 in the blocking position. When in the blocking position, the limiting member 211 holds the pushing member 222 in the locked state, and when in the non-blocking position, the limiting member 211 releases the pushing member 222 to switch the pushing member 222 from the locked state to the released state. When the inertia member 204 moves away from the initial position relative to the handle seat 201 in response to an acceleration of the vehicle exceeding a threshold, the limiting member 211 moves from the blocking position to the non-blocking position to release the pushing member 222, which allows the pushing member 222 to move to drive the handle 202 to move from the retracted position to the deployed position. As shown in FIGS. 2A and 2B, the limiting member 211 moves toward the blocking wall 233 in the opening 234 of the accommodating housing 231 to move from a blocking position to a non-blocking position thereof.

The pushing member 222 includes a blocked portion 223 and a first pushed portion 224. The blocked portion 223 is configured to abut against the limiting member 211, such that the pushing member 222 can be held in the locked state by the limiting member 211. The first pushed portion 224 is connected to the first biasing member 208 such that the first biasing member 208 is arranged between the pushing member 222 and the handle seat 201. As shown in FIG. 2A, when the pushing member 222 is in the locked state, the pushing member 222 applies a pressing force to the first biasing member 208, causing the first biasing member 208 to be biased. Therefore, the first biasing member 208 applies a first biasing force to the pushing member 222 to push the pushing member 222 to move when the pushing member 222 is in the released state. It should be understood that the arrangement position and manner of the first biasing member 208 are exemplary, and in other embodiments, the first biasing member 208 may be arranged in other positions and manners as long as it can apply the first biasing force to the pushing member 222.

The limiting member 211 includes a support end 212, a second pushed portion 214, a channel 213, and a blocking portion 215. The support end 212 is configured to abut against the inertia member 204 to support the inertia member 204. When the inertia member 204 is in the initial position, the inertia member 204 abuts between the blocking wall 233 and the support end 212. The second pushed portion 214 is connected to the second biasing member 210 such that the second biasing member 210 is arranged between the limiting member 211 and the handle seat 201. As shown in FIG. 2A, when the limiting member 211 is in the blocking position, the limiting member 211 applies a pressing force to the second biasing member 210, causing the second biasing member 210 to be biased. Therefore, the second biasing member 210 applies a second biasing force to the limiting member 211, such that the inertia member 204 is held in the initial position by the limiting member 211 and the blocking wall 233. When the inertia member 204 moves relative to the handle seat 201 in response to an acceleration of the vehicle exceeding a threshold, the inertia member 204 is separated from the support end 212 to move away from the initial position, such that the limiting member 211 is allowed to move toward the blocking wall 233 to a non-blocking position under the action of the second biasing force. The channel 213 is farther from the blocking wall 233 than the blocking portion 215. When the limiting member 211 is in the blocking position, the blocking portion 215 engages with the blocked portion 223 of the pushing member 222. When the limiting member 211 is in the non-blocking position, the channel 213 is aligned with the pushing member 222, which allows at least part of the pushing member 222 to pass through the channel 213 to move toward the handle 202 to drive the handle 202 to the deployed position. It should be understood that the arrangement position and manner of the second biasing member 210 are exemplary, and in other embodiments, the second biasing member 210 may be arranged in other positions and manners as long as it can apply the second biasing force to the limiting member 211.

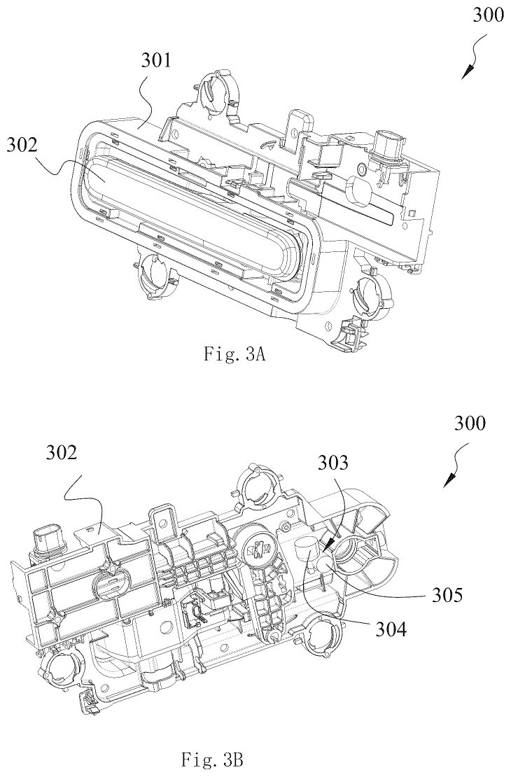

FIGS. 3A and 3B are front and rear illustrative perspective views of a handle assembly 300 according to another embodiment of the present disclosure. The handle assembly 300 includes a handle seat 301 and a handle 302 connected to the handle seat 301. An inertia drive device 303 is provided on the handle seat 301 for driving the handle 302 from a retracted position to an deployed position. The handle assembly 300 according to this embodiment is different from the handle assembly 200 shown in FIGS. 2A and 2B in that the inertia drive device 303 has a different configuration from the inertia drive device 203. It should be understood that. if the similarities of the handle assembly 300 with the handle assembly 200 are not described below, and the description of the handle assembly 200 is also applicable to the handle assembly 300.

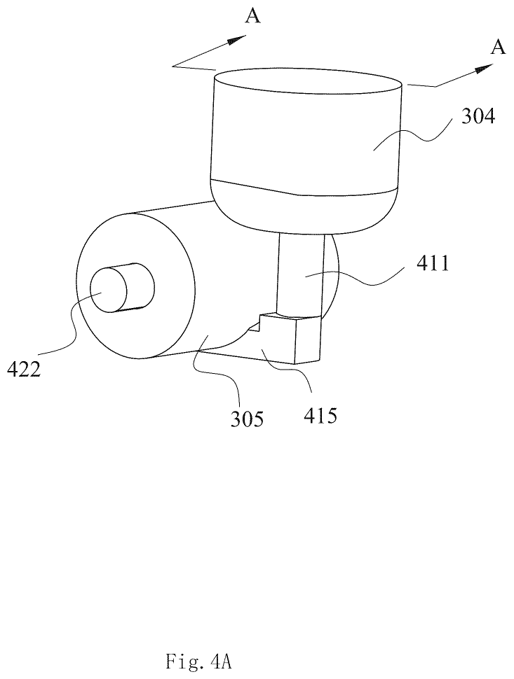

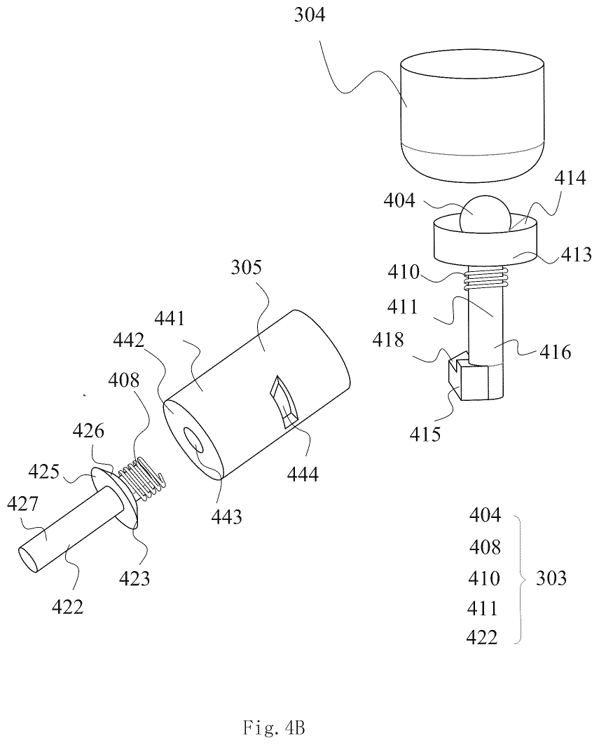

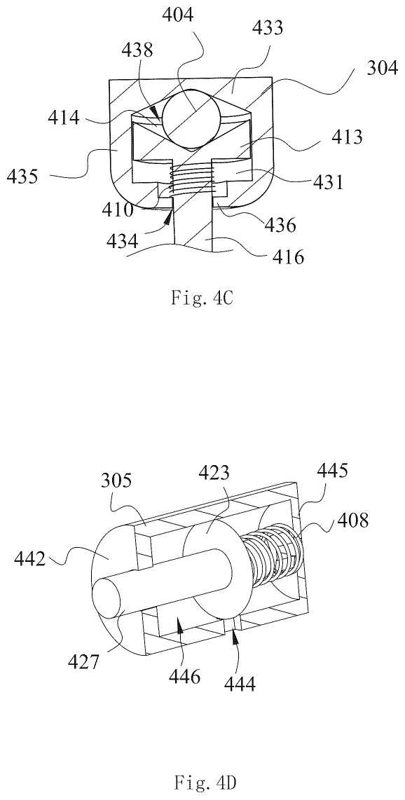

FIGS. 4A to 4D show the overall structure of the inertia drive device 303 shown in FIG. 3B and the arrangement of the inertia drive device 303 in the handle seat 301. FIG. 4A is a perspective view of the inertia drive device 303. In FIG. 4A, the inertia drive device 303 is accommodated in the handle seat 301. FIG. 4B is an exploded view of the inertia drive device 303 in FIG. 4A. FIG. 4C is a cross-sectional view of some components of the inertia drive device 303 shown in FIG. 4A taken along line A-A in FIG. 3A, showing that an inertia member 404 is accommodated in a first accommodating housing 304 of the handle seat 301. FIG. 4D is a cross-sectional perspective view of some components of the inertia drive device 303 shown in FIG. 4A, showing that a pushing member 422 is accommodated in a second accommodating housing 305 of the handle seat 301.

In the handle assembly 300, the inertia drive device 303 includes an inertia member 404, a first biasing member 408, a second biasing member 410, a limiting member 411, and a pushing member 422. The handle seat 301 includes a first accommodating housing 304 and a second accommodating housing 305 for accommodating or partially accommodating the components of the inertia drive device 303.

The first accommodating housing 304 defines a first chamber 431. The inertia member 404 is located in the first chamber 431 and can move in the first chamber 431. The first accommodating housing 304 is formed with a blocking wall 433, a first peripheral wall 435 and a support wall 436. The blocking wall 433 is arranged opposite to the support wall 436, and the first peripheral wall 435 connects the blocking wall 433 and the support wall 436. The support wall 436 is formed with an opening 434. The opening 434 is in communication with the first chamber 431, allowing the limiting member 411 to partially insert into the first chamber 431 through the opening 434 and move in the opening 434 toward or away from the blocking wall 433.

The limiting member 411 includes a support seat 413 and a limiting rod 416 with the support seat 413 being provided on one end of the limiting rod 416. The support seat 413 is located in the first chamber 431, and the limiting rod 416 partially inserts into the first chamber 431 and can move in the opening 434 of the first chamber 431. The support seat 413 is at a certain distance from the support wall 436 to permit the limiting member 411 to move away from the blocking wall 433. The support seat 413 and the blocking wall 433 define a clamping space 438 therebetween, and the inertia member 404 is accommodated in the clamping space 438. When the inertia member 404 is in the initial position, the inertia member 404 is located between the blocking wall 433 and the support seat 413, abutting against the blocking wall 433 and the support seat 413. The circumferential dimension of the support seat 413 matches the inner diameter of the first chamber 431, such that when the inertia member 404 moves relative to the handle seat 301 in response to an acceleration of the vehicle exceeding a threshold, the inertia member 404 is held on the support seat 413 within the clamping space 438 between the blocking wall 433 and the support seat 413 and the support seat 413 is movable in the first chamber 431 away from the blocking wall 433.

When an acceleration of the vehicle resulting from an external collision from any direction exceeds a threshold in any horizontal direction, the inertia member 404 moves on the support seat 413 relative to the support seat 413 away from the initial position. Moreover, along the movement path of the inertia member 404 relative to the support seat 413, the distance between the surface 414 of the support seat 413 and the blocking wall 433 gradually decreases, such that the movement of the inertia member 404 relative to the support seat 413 drives the limiting member 411 to move away from the blocking wall 433 to the non-blocking position. In the embodiment as shown, the distance between the surface 414 of the support seat 413 and the blocking wall 433 decreases from the middle to the edge, such that when the inertia member 404 moves, in response to an acceleration of the vehicle resulting from an external collision from any direction exceeds a threshold in any horizontal direction, relative to the support seat 413 away from the initial position, the inertia member 404 can drive the limiting member 411 to move away from the blocking wall 433 to the non-blocking position. In the embodiment as shown, the surface 414 of the support seat 413 and the blocking wall 433 have conical concave shapes that are mirrored to each other, such that the distance between the surface 414 of the support seat 413 and the blocking wall 433 gradually decreases from the center to the edge. In some embodiments, the surface 414 of the support seat 413 and the blocking wall 433 are configured to have other concave shapes. In some other embodiments, only one of the surface 414 of the support seat 413 and the blocking wall 433 is configured to have a concave shape.

The inertia member 404 can also move away from the initial position by moving toward and directly pushing the support seat 413 to move together with it (i.e., not relative to the support seat 413) in response to an acceleration of the vehicle exceeding a threshold in a vertical direction. In this connection, in the event of vehicle fall, the inertia drive device 303 can also drive the handle 302 to deploy based on the movement of the inertia member 404. Moreover, with the inertia drive device 303 being mounted with 180°-rotation relative to the direction shown in the figure, such movement of the inertia member 404 enables the inertia drive device 303 to drive the handle 302 to deploy based on the movement of the inertia member 404 in the event of vehicle fall subsequent to a 180-degree vehicle rollover event.

The limiting rod 416 of the limiting member 411 partially inserts into the first chamber 431 through the opening 434 of the first accommodating housing 304, and can move in the opening 434 in response to the movement of the inertia member 404. The second biasing member 410 is arranged in the first chamber 431. The second biasing member 410 is sleeved on the portion of the limiting rod 416 inserting into the first chamber 431, and is located between the support seat 413 and the support wall 436 of the first accommodating housing 304. When the inertia member 404 is in the initial position, the support seat 413 applies a pressing force to the second biasing member 410, causing the second biasing member 410 to be biased. Thus, the second biasing member 410 applies a second biasing force to the limiting member 411 such that the support seat 413 of the limiting member 411 and the blocking wall 433 hold the inertia member 404 in the initial position. When the inertia member 404 moves relative to the handle seat 301 in response to an acceleration of the vehicle exceeding a threshold, the inertia member 404 drives the limiting member 411 to move away from the blocking wall 433 to the non-blocking position with overcoming the biasing force from the second biasing member 410. In the embodiment as shown, the second biasing member 410 is a spring. In other embodiments, the second biasing member 410 is in other forms. Moreover, in other embodiments, the second biasing member 410 can be arranged in other positions.

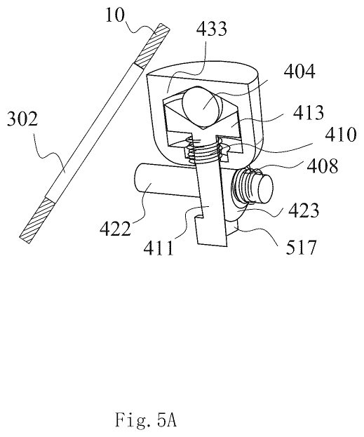

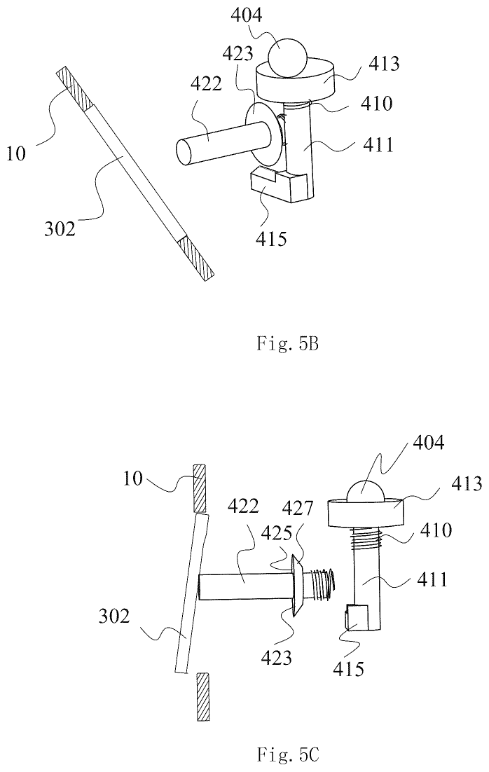

The limiting member 411 includes a blocking portion 415 arranged on a limiting rod 416. In the embodiment as shown, the blocking portion 415 is a blocking block protruding from the limiting rod 416 of the limiting member 411. In other embodiments, the blocking portion 415 may be configured in other forms. The blocking portion 415 has a blocking surface 517 (see FIG. 5A). When the limiting member 411 is in the blocking position, the blocking portion 415 engages with the pushing member 422 via the blocking surface 517. When the limiting member 411 is in the non-blocking position, the blocking portion 415 is disengaged from the pushing member 422. The blocking portion 415 further has a first angled surface 418 for mating with the pushing member 422 to guide the pushing member 422 to return from the released state to the locked state.

The pushing member 422 includes a pushing rod 427 and a blocked portion 423 provided on the pushing rod 427. In the embodiment as shown, the blocked portion 423 is a boss provided on the pushing rod 427. In other embodiments, the blocked portion 423 may be configured in other forms. The blocked portion 423 has a blocked surface 425 and a second angled surface 426. When the limiting member 411 is in the blocking position, the blocked portion 423 engages with the blocking portion 415 with the blocked surface 425 abutting against the blocking surface 517 (see FIG. 5A). When the limiting member 411 is in the non-blocking position, the blocked surface 425 is separated from the blocking surface 517, such that the blocked portion 423 is disengaged from the blocking portion 415. The second angled surface 426 of the blocked portion 423 mates with the first angled surface 418 of the blocking portion 415 to guide the pushing member 422 to return from the released state to the locked state.

The second accommodating housing 305 defines a second chamber 446. The blocked portion 423 of the pushing member 422 is accommodated in the second chamber 446, and the pushing rod 427 is at least partially accommodated in the second chamber 446. The second accommodating housing 305 includes a second peripheral wall 441, a front wall 442, and a rear wall 445. The front wall 442 and the rear wall 445 are opposite to each other, and the second peripheral wall 441 connects the front wall 442 and the rear wall 445. The front wall 442 is provided with a hole 443 in communication with the second chamber 446, allowing the pushing member 422 to at least partially extend out of the second chamber 446 through the hole 443 to drive the handle 302. The second peripheral wall 441 is provided with a window 444 in communication with the second chamber 446, allowing the blocking portion 415 of the limiting member 411 to at least partially insert through the window 444 into the second chamber 446 to engage with the blocked portion 423 of the pushing member 422.

The first biasing member 408 is arranged in the second chamber 446. The first biasing member 408 is sleeved on the pushing rod 427 and located between the blocked portion 423 and the rear wall 445 of the second accommodating housing 305. When the pushing member 422 is in the locked state, the blocked portion 423 of the pushing member 422 applies a pressing force to the first biasing member 408, causing the first biasing member 408 to be biased to apply a first biasing force to the pushing member 422. Thus, when the pushing member 422 is in the released state, the first biasing member 408 pushes the pushing member 422 to move to drive the handle 302. In the embodiment as shown, the first biasing member 408 is a spring. In other embodiments, the first biasing member 408 is in other forms. Moreover, in other embodiments, the first biasing member 408 can be arranged in other positions.

FIGS. 5A to 5C are illustrative views illustratively showing a process of the handle 302 being pushed from the retracted position to the deployed position by the inertia drive device 303. FIG. 5A shows the inertia drive device 303 in a working state in which the pushing member 422 is held in a locked state by the limiting member 411 and the handle 302 is in a retracted position. FIG. 5B shows the inertia drive device 303 in another working state in which the pushing member 422 has just been released by the limiting member 411 and the handle 302 is still in the retracted position. FIG. 5C shows the inertia drive device 303 in another working state in which the pushing member 422 has pushed the handle 302 to the deployed position.

As shown in FIG. 5A, the inertia member 404 is in an initial position. At this moment, the inertia member 404 is held between the support seat 413 and the blocking wall 433 and is located at the center of the support seat 413. The support seat 413 applies a pressing force to the second biasing member 410, causing the second biasing member 410 to apply a second biasing force to the support seat 413, such that the inertia member 404 is held in the initial position by the support seat 413 and the blocking wall 433. When the inertia member 404 is in the initial position, the limiting member 411 is in the blocking position. In the blocking position, the blocking portion 415 of the limiting member 411 abuts against the blocked portion 423 of the pushing member 422 via the blocking surface 517, such that the limiting member 411 holds the pushing member 422 in the locked position, preventing the pushing member 422 from moving toward the handle 302 to drive the handle 302. Therefore, when the inertia member 404 is in the initial position, the handle 302 is in the retracted position where it is flush with the vehicle exterior sheet metal 10.

When the vehicle generates an acceleration exceeding a threshold in the event of a collision, fall, etc., as shown in FIG. 5B, the inertia member 404 moves away from the initial position due to the inertia motion. Such movement of the inertia member 404 drives the limiting member 411 to move away from the blocking wall 433 (see FIG. 5A) of the first accommodating housing 304 to the non-blocking position with overcoming the second biasing force applied by the second biasing member 410. When in the non-blocking position, the blocking portion 415 of the limiting member 411 is disengaged from the blocked portion 423 of the pushing member 422 to switch the pushing member 422 to the released state. The pushing member 422 in the released state can move toward the handle 302 under the action of the first biasing force provided by the first biasing member 408 (see FIG. 5A). In the state shown in FIG. 5B, the limiting member 411 has just disengaged from the pushing member 422 to release the locking of the pushing member 422, and the pushing member 422 has not yet moved to the handle 302 to push the handle 302, such that the handle 302 is still in the retracted position in which it is flush with the vehicle exterior sheet metal 10. In the state shown in FIG. 5B, since the limiting member 411 is driven to move away from the blocking wall 433 (see FIG. 5A) of the first accommodating housing 304, the second biasing member 410 is further biased to apply a larger second biasing force to the limiting member 411. The second biasing force enables the limiting member 411 to return to the blocking position thereof.

When the pushing member 422 reaches the released state shown in FIG. 5B, the first biasing force applied to the pushing member 422 by the first biasing member 408 drives the pushing member 422 to move toward the handle 302. As shown in FIG. 5C, the pushing member 422 moves to abut against the handle 302 under the action of the first biasing force, and pushes the handle 302 to the deployed position in which it protrudes out relative to the vehicle exterior sheet metal 10. In the state shown in FIG. 5C, the inertia member 404 returns to the initial position under the guidance of the concave surface 414 of the support seat 413 (see FIG. 4C), such that the limiting member 411 returns to the blocking position under the action of the second biasing force applied by the second biasing member 410. Since the pushing member 422 has moved toward the handle 302, the limiting member 411 that has returned to the blocking position does not engage with the pushing member 422.

The handle 302 can be pushed back from the deployed position to the retracted position. Moreover, by the appropriate arrangement of the handle 302, the handle 302 can be pushed beyond the retracted position and then returned to the retracted position. Therefore, in the embodiment of the handle assembly 300, the pushing member 422 can be pushed by the handle 302 to return and engage with the limiting member 411 by pushing the handle 302 toward the retracted position. Specifically, when the handle 302 is pushed from the deployed position shown in FIG. 5C to the retracted position, the handle 302 pushes the pushing member 422 to move toward the limiting member 411. The pushing member 422 can be pushed by the handle 302 until the second angled surface 426 of the blocked portion 423 touches and then slides against the first angled surface 418 (see FIG. 4B) of the blocking portion 415 of the limiting member 411. The first angled surface 418 mates with the second angled surface 426 in this manner to guide the pushing member 422 to further move under the action of the handle 302 until the second angled surface 426 passes over the first angled surface 418 and the blocking surface 517 (see FIG. 5A) of the blocking portion 415 abuts against the blocked surface 425 of the blocked portion 423. During the slide of the second angled surface 426 against the first angled surface 418, the limiting member 411 is pushed by the pushing member 422 to move away from the blocking wall 433 of the first accommodating housing 304 (see FIG. 4C), and moves, after the second angled surface 426 passes over the first angled surface 418, toward the blocking wall 433 and returns to the blocking position. In this way, the first biasing member 408, the second biasing member 410, the limiting member 411 and the pushing member 422 return to the state shown in FIG. 5A. During this process, the inertia member 404 is held at the center of the support seat 413.

As will be appreciated by those of ordinary skill in the art, the handle assembly of the present disclosure can not only be used to drive a rotary flush handle to deploy, but also be used to drive a push-type flush handle (e.g., having a four-bar linkage) to deploy.

The handle assembly of the present disclosure can drive the handle based on the movement of the inertia member in response to an acceleration of the vehicle exceeding a threshold, to enable the handle to reach the deployed position, such that the operator can grasp the handle to open the door. Therefore, in the event of a collision, etc. of the vehicle, the handle can be driven to the deployed position based on the movement of the inertia member, without the need to use a motor to drive the handle to the deployed position. This can avoid the situation where the door cannot be opened, in the event of a collision, etc. of the vehicle, due to the failure of the motor for driving the handle.

In the handle assembly of the present disclosure, the inertia member can move away from the initial position in response to an acceleration of the vehicle resulting from an external collision from any direction exceeding a threshold in any horizontal direction, and the handle can be driven to move based on the movement of the inertia member. In some embodiments, the inertia member can move away from the initial position in response to an acceleration exceeding a threshold in the vertical direction in the event of vehicle fall or vehicle fall subsequent to a 180-degree vehicle rollover event, and the handle is driven to move based on the movement of the inertia member.

In the handle assembly of the present disclosure, through the proper configuration of the blocking wall and the limiting member, the retaining force provided by the blocking wall and the limiting member on the inertia member can be set as required, such that the vehicle acceleration threshold causing the inertia member to move can be set as required. Moreover, by setting the retaining force provided by the blocking wall and the limiting member on the inertia member to be large enough, the inertia member will move away from the initial position only when an acceleration of the vehicle is large enough. Therefore, normal operation of the vehicle will not cause the movement of the inertia member away from the initial position and thus will not cause an undesired deploy of the handle.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting; therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

### DESCRIPTION OF MAIN REFERENCE SIGNS

Vehicle Exterior Sheet Metal 10
Handle Assembly 100/200/300
Handle Seat 101/201/301
Handle 102/202/302
Inertia Drive Device 103/203/303
Pushing Member 122/222/422
First Biasing Member 208/408
Inertia Member 204/404
Second Biasing Member 210/410
Limiting Member 211/411
Support End 212
Channel 213
Second Pushed Portion 214
Blocking Portion 215/415
Blocked Portion 223/423
First Pushed Portion 224
Accommodating Housing 231
Chamber 232
Blocking Wall 233/433
Opening 234/434
First Accommodating Housing 304
Second Accommodating Housing 305
Support Seat 413
Surface 414
Limiting Rod 416
First Angled Surface 418
Blocked Surface 425
Second Angled Surface 426
Pushing Rod 427
First Chamber 431
First Peripheral Wall 435
Support Wall 436
Clamping Space 438
Second Peripheral Wall 441
Front Wall 442
Window 444
Rear Wall 445
Second Chamber 446
Blocking Surface 517

What is claimed is:

1. A handle assembly for a vehicle, characterized by comprising:
a handle seat;
a handle connected to the handle seat and having a retracted position and a deployed position;
a pushing member movably provided on the handle seat and having a locked state and a released state, the pushing member being capable of driving the handle to move when moving;
a limiting member movably provided on the handle seat and having a blocking position in which the limiting member holds the pushing member in the locked state and a non-blocking position in which the limiting member releases the pushing member to switch the pushing member from the locked state to the released state; and
an inertia member configured to hold the limiting member in the blocking position when in its initial position;
wherein the inertia member is configured to move away from the initial position relative to the handle seat in response to an acceleration of the vehicle exceeding a threshold, such that the limiting member moves from the blocking position to the non-blocking position to release the pushing member, thereby allowing the pushing member to move to drive the handle to move from the retracted position to the deployed position.

2. The handle assembly according to claim 1, characterized by further comprising:
a first biasing member arranged between the pushing member and the handle seat and configured to apply a first biasing force to the pushing member to push the pushing member to move when the pushing member is in the released state.

3. The handle assembly according to claim 2,
wherein the handle seat comprises a blocking wall, and the inertia member is located between the blocking wall and the limiting member when in the initial position; and
wherein the handle assembly further comprises a second biasing member which is arranged between the limiting member and the handle seat and configured to apply a second biasing force to the limiting member to hold the inertia member in the initial position by means of the limiting member and the blocking wall.

4. The handle assembly according to claim 3, wherein the limiting member comprises a support end, the inertia member abutting against the support end when in the initial position, and separating from the support end when the inertia member moves relative to the handle seat in response to the acceleration of the vehicle exceeding a threshold to allow the limiting member to move toward the blocking wall to the non-blocking position under the action of the second biasing force.

5. The handle assembly according to claim 4, wherein the limiting member comprises a blocking portion and a channel with the channel being farther from the blocking wall than the blocking portion, the blocking portion engaging with the pushing member when the limiting member is in the blocking position, and the channel aligning with the pushing member when the limiting member is in the non-blocking position to allow at least part of the pushing member to pass through the channel to drive the handle.

6. The handle assembly according to claim 3,
wherein the limiting member comprises a support seat defining a clamping space between the support seat and the blocking wall, and the inertia member is accommodated in the clamping space; and
wherein when the inertia member moves relative to the handle seat in response to the acceleration of the vehicle exceeding a threshold, the inertia member is movable on the support seat relative to the support seat, and along the movement path of the inertia member relative to the support seat, a distance between a surface of the support seat and the blocking wall gradually decreases, such that the movement of the inertia member relative to the support seat drives the limiting member to move away from the blocking wall to the non-blocking position.

7. The handle assembly according to claim 6, wherein at least one of the surface of the support seat and the blocking wall has a concave shape.

8. The handle assembly according to claim 6,
wherein the handle seat comprises a first accommodating housing which forms the blocking wall, the first accommodating housing defining a first chamber and having an opening in communication with the first chamber;
wherein the limiting member further comprises a limiting rod with the support seat being provided on one end of the limiting rod; and
wherein the inertia member and the support seat are located in the first chamber, and the limiting rod of the limiting member is movable in the opening.

9. The handle assembly according to claim 8, wherein the limiting member comprises a blocking portion provided on the limiting rod, and the pushing member comprises a blocked portion, the blocked portion being engaged with the blocking portion when the limiting member is in the blocking position, and the blocked portion being disengaged from the blocking portion when the limiting member is in the non-blocking position.

10. The handle assembly according to claim 9, wherein the blocking portion comprises a first angled surface and the blocked portion comprises a second angled surface, the first angled surface and the second angled surface mating with each other to guide the pushing member to return from the released state to the locked state.

11. The handle assembly according to claim 8, wherein the second biasing member is disposed in the first chamber between the support seat and the first accommodating housing.

12. The handle assembly according to claim 9,
wherein the handle seat comprises a second accommodating housing which defines a second chamber and has a hole in communication with the chamber, wherein the blocked portion of the pushing member is located in the second chamber, and the pushing member is capable of at least partially extending out of the second chamber through the hole to drive the handle; and
wherein the second accommodating housing is provided with a window, and the blocking portion of the limiting member at least partially passes through the window and inserts into the second chamber to engage with the blocked portion.

13. The handle assembly according to claim 12, wherein the first biasing member is disposed in the second chamber between the pushing member and the second accommodating housing.

14. The handle assembly according to claim 1, wherein the inertia member is an inertia ball.

15. A vehicle comprising a handle assembly according to claim 1.
